(19) United States
(12) Patent Application Publication
(10) Pub. No.: US 2019/0132054 A1
(43) Pub. Date: May 2, 2019

(54) MODULATION DEVICE, MODULATION METHOD, LIGHT EMISSION APPARATUS, AND LIGHTING FIXTURE OR SIGNBOARD USING LIGHT EMISSION APPARATUS

(71) Applicant: Panasonic Intellectual Property Management Co., Ltd., Osaka (JP)

(72) Inventors: Shigeru IDO, Osaka (JP); Keisuke SEKI, Osaka (JP); Kazuhiko HAYASHI, Osaka (JP)

(21) Appl. No.: 16/168,221

(22) Filed: Oct. 23, 2018

(30) Foreign Application Priority Data
Oct. 26, 2017 (JP) 2017-207213

(51) Int. Cl. H04B 10/516; H04L 7/00; H04B 10/80

(52) U.S. Cl. CPC H04B 10/516; H04B 10/80; H04L 7/0075

(57) ABSTRACT

A modulation device includes: a signal input circuit that receives an external input signal and outputs the signal downstream as a first signal; and an arithmetic processor positioned downstream of the signal input circuit. The arithmetic processor is configured to: determine when an external ID signal including ID information has been input as the first signal, and when determining that an external ID signal including ID information has been input as the first signal, acquire the ID information from the external ID signal, obtain transmission timing synchronizing with the first signal based on the external ID signal, and output a light source drive signal that drives a light source according to the ID information based on the transmission timing synchronizing with the input signal.

### CROSS-REFERENCE TO RELATED APPLICATIONS

This application claims priority to Japanese Patent Application No. 2017-207213 filed on Oct. 26, 2017. The entire disclosure of this application is incorporated herein by reference.

### BACKGROUND

The present disclosure relates to a modulation device, a modulation method, a light emission apparatus, and a lighting fixture or a signboard using the light emission apparatus.

A light emission apparatus (modulation device) configured to permit visible light communication in which information is conveyed using blinking of a light source is known. For example, Japanese Unexamined Patent Publication No. 2016-225926 (Patent Document 1) discloses a light emission system constituted by a plurality of light emission apparatuses capable of performing optical communication such as visible light communication. In such a light emission system, the plurality of light emission apparatuses are required to transmit the same identification (ID) information in synchronization with each other.

Also, in uses of large-scale electronic signboards, etc., there are needs for using a number of light emission apparatuses connected in series and/or in parallel.

In the conventional technology like Patent Document 1, however, in connection of a number of light emission apparatuses, there is a fear of occurrence of a lag in synchronization signals among the light emission apparatuses. Once this occurs, an optical communication receiving device located in a region where light rays from the plurality of light emission apparatuses overlap, for example, may fail to read ID information or reads ID information mistakenly. That is, there arises a problem of affecting the readability of ID information. In a general light emission apparatus, an input terminal and an inner component circuit (e.g., a microcomputer for generating and outputting the synchronization signal) are isolated from each other using an isolating means such as a photocoupler. The above problem may occur due to transmission delay (e.g., 0.5 μs) of this isolating means.

### SUMMARY

An objective of the present disclosure is providing a modulation device capable of blinking a light source in each light emission apparatus so that the readability of ID information can be sufficiently secured irrespective of the number of light emission apparatuses installed.

To attain the above objective, the modulation device according to one aspect of the disclosure includes: a signal input circuit that receives an external input signal and outputs the signal downstream as a first signal; and an arithmetic processor positioned downstream of the signal input circuit. The arithmetic processor is configured to: determine when an external ID signal including ID information has been input as the first signal, and when determining that an external ID signal including ID information has been input as the first signal, acquire the ID information from the external ID signal, obtain transmission timing synchronizing with the first signal based on the external ID signal, and output a light source drive signal that drives a light source according to the ID information based on the transmission timing synchronizing with the input signal.

According to the present disclosure, the modulation device can blink the light source in each light emission apparatus so that the readability of ID information can be sufficiently secured irrespective of the number of light emission apparatuses installed.

### BRIEF DESCRIPTION OF THE DRAWINGS

FIG. 1 is a view showing an example of connection of signboards using light emission apparatuses in series.

FIG. 2 is a block diagram showing an example configuration and example connection of the light emission apparatuses in the configuration of FIG. 1.

FIG. 3 is a block diagram showing an example configuration of a modulation device.

FIG. 4 is a flowchart showing an example operation of the light emission apparatus.

FIG. 5 is a flowchart showing an example operation in a signal detection mode.

FIG. 6 is a timing chart showing an example operation of the light emission apparatus.

FIG. 7 is a view showing timing for explaining the operation related to a reproduction mode of the light emission apparatus.

FIG. 8 is a view showing an example of lighting fixtures using the light emission apparatuses.

FIG. 9 is a block diagram showing an example of connection of a plurality of light emission apparatuses in parallel.

### DETAILED DESCRIPTION

Embodiments of the present disclosure will be described herein in detail based on the accompanying drawings. It should be noted that the following description of the embodiments is essentially mere illustration and by no means intended to restrict the present disclosure, applications thereof, or uses thereof.

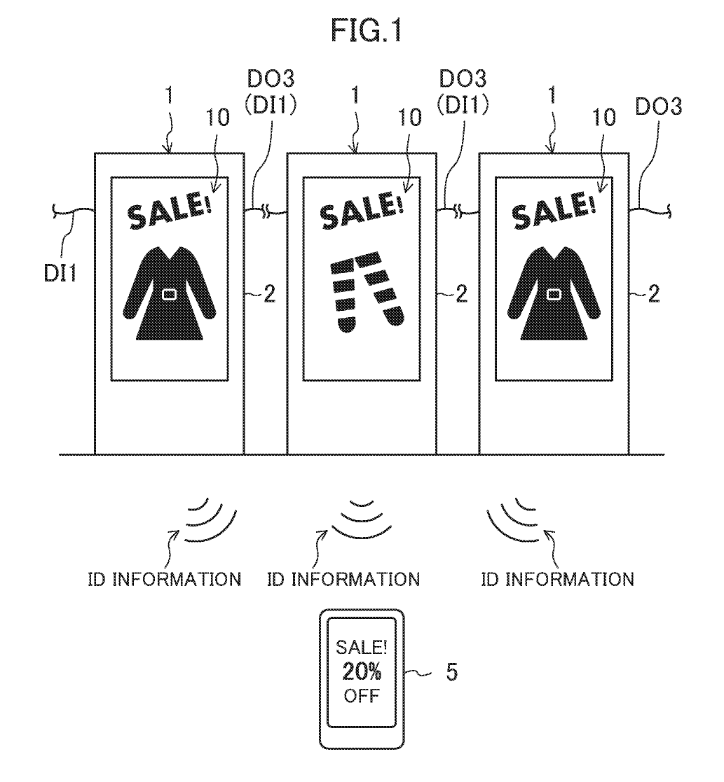

FIG. 1 shows a state of installation of a plurality of units of digital signage 1 as signboards each using a light emission apparatus according to an embodiment. To each unit of digital signage 1, attached is a light emission apparatus 10 configured to permit visible light communication in which information is conveyed to a receiving terminal by performing high-speed blinking according to ID information. In other words, the light emission apparatus 10 has a function of transmitting ID information to a receiving terminal 5 while exhibiting a display so as to be recognized as the digital signage 1 by human eyes.

The digital signage 1 has a housing 2 that accommodates the light emission apparatus 10. The light emission apparatus 10 is accommodated in the housing 2 so that the display surface thereof for displaying advertisements, etc. by allowing transmission of light from a light source 13 to be described later be exposed outside.

### —Configuration of Light Emission Apparatus—

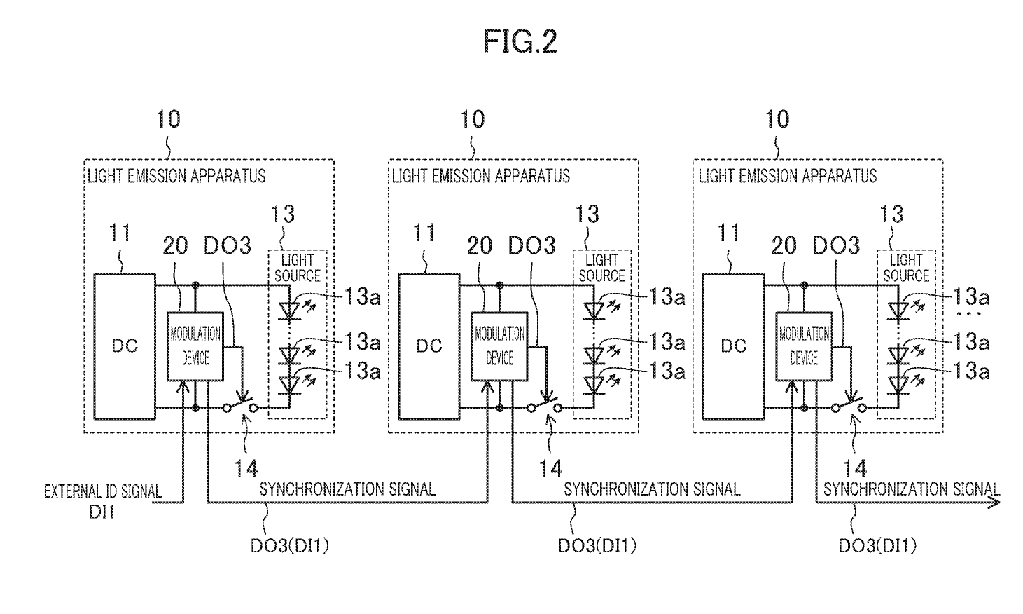

FIG. 2 is a block diagram mainly illustrating the configuration of the light emission apparatuses 10 in the configuration of FIG. 1. As shown in FIG. 2, each light emission apparatus 10 includes a light source 13, a power source 11 that supplies electric power to the light source 13, a switch 14 provided between the light source 13 and the power source 11 for controlling the on/off state of the connection therebetween, and a modulation device 20. The modulation device 20 has a function of intermittently changing the electric power supplied from the power source 11 to the light source 13 by controlling the on/off state of the switch 14 with a light source drive signal DO3 to be described later, thereby blinking the light source 13 according to ID information.

The light source 13 is not specifically limited as far as it is capable of intermittent light emission. For example, as the light source, light emitting devices such as light emitting diodes (LEDs) 13a can be suitably used. The LEDs 13a are connected in series as shown in FIG. 2 or connected in an array, to constitute a display panel (e.g., 50 W), an indicating lamp, etc..

The power source is not specifically limited as far as it can supply electric power to the light source 13. For example, it can be a DC power source 11. The DC power source 11 can suitably use a battery, a power converter that generates a DC power source from a commercial power source, etc., for example.

The switch 14 is provided on a power source line (including a ground line) connecting the DC power source 11 and the light source 13. The form of the switch 14 is not specifically limited, but a switching transistor (not shown) can be used suitably. In this case, the light source drive signal DO3 is given to the gate of the transistor.

—Configuration of Modulation Device—

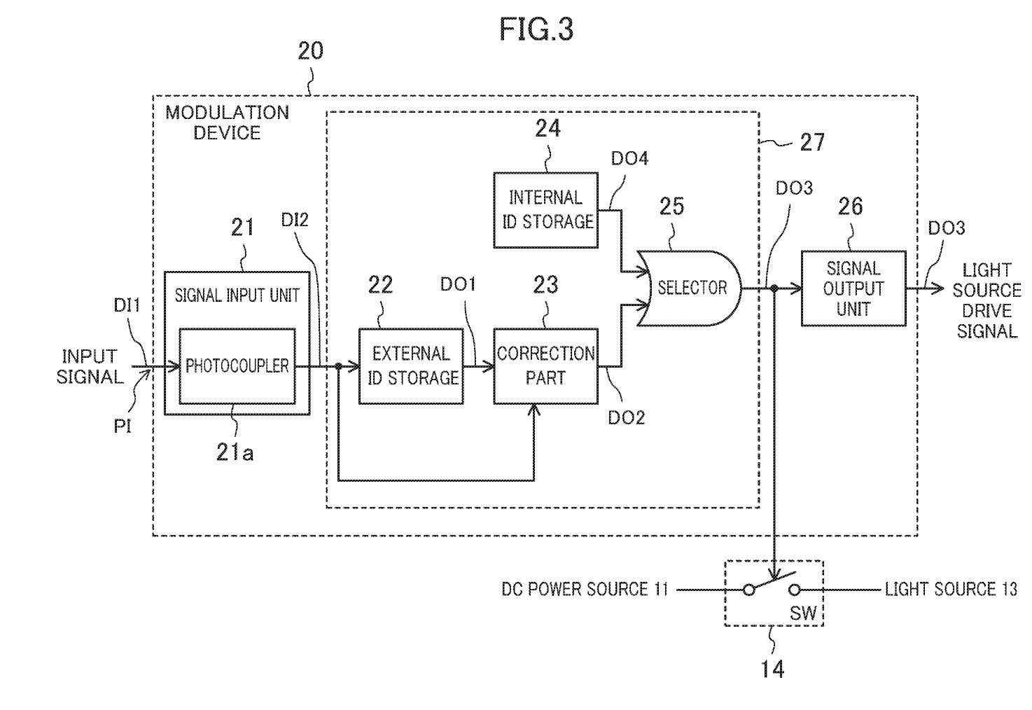

FIG. 3 is a block diagram showing the configuration of the modulation device 20. As shown in FIG. 3, the modulation device 20 includes a signal input unit 21 (example of a signal input circuit) that receives an input signal DI1 from outside and an arithmetic processor 27 positioned downstream of the signal input unit 21. The modulation device 20 further includes a signal output unit 26 (example of a signal output circuit), positioned downstream of the arithmetic processor 27, that outputs the light source drive signal DO3 (ID signal) outside the light emission apparatus 10 based on transmission timing to be described later.

The signal input unit 21 includes a photocoupler 21a as a light converter that converts the input signal DI1 to light energy. The photocoupler 21a has a function as an isolating means for securing isolation between an input terminal PI of the modulation device 20 (outside the modulation device 20) and the arithmetic processor 27. Note that, as the light converter, any other light converting means may be used in place of the photocoupler 21a. Also, the photocoupler 21a may be replaced with any other isolating means, e.g., a transformer.

The signal output unit 26 has a function of outputting the light source drive signal DO3 outside, and, although the concrete form thereof is not specifically limited, can be implemented by an output buffer circuit (not shown) constituted by a transistor, etc., for example.

The arithmetic processor 27 has a function of controlling the operation of the modulation device 20, and can be implemented by a microcomputer, for example. The microcomputer executes a program, and thereby the function of the arithmetic processor 27 in the present disclosure is implemented. The microcomputer includes, as a main hardware component, a processor that operates in accordance with the program. As long as the processor can implement the function by executing the program, the type of the processor does not matter. The processor is configured to include one or more electronic circuits including a semiconductor integrated circuit (IC) or a large scale integrated circuit (LSI). Although an electronic circuit is called an IC or an LSI here, the name of it changes depending on the degree of integration, and it may be one called a system LSI, a very large scale integrated circuit (VLSI), or an ultra large scale integrated circuit (VLSI). A field programmable gate array (FPGA) programmed after manufacturing of the LSI, or a reconfigurable logic device capable of junction-related reconfiguration inside the LSI or setting up of circuit blocks inside the LSI can also be used for the same purpose. The multiple electronic circuits may be integrated on one chip or provided on multiple chips. The multiple chips may be integrated in one apparatus or provided in multiple apparatuses. The program is recorded in a computer-readable non-transitory recording medium such as a ROM, an optical disc, or a hard disk drive. The program may be stored on the recording medium in advance or supplied to the recording medium via a wide area communication network such as the Internet. The program may be stored in the same recording medium as the external ID storage 22 and the internal ID storage 24 in the present disclosure, or stored in different recording media from each other.

An input signal DI2 (example of a first signal) is input into the arithmetic processor 27 via the signal input unit 21. When determining that an external ID signal has been input as the input signal DI2, the arithmetic processor 27 acquires ID information from the external ID signal. Also, the arithmetic processor 27 obtains transmission timing synchronizing with the input signal DI1 from outside based on the external ID signal, and outputs the light source drive signal DO3 (ID signal) corresponding to the ID information based on the transmission timing. Note that, as used herein, “synchronizing” refers to substantially synchronizing. For example, when the precision of an outgoing signal (blinking signal) (e.g., within ±0.5%) has been established under the standards of visible light communication and other agreements such as specifications, a signal falling within such a range can be regarded as a substantially synchronizing signal (timing). In other words, “synchronizing” is a concept that includes (accepts) a lag in timing within a given range in which the readability of ID information can be sufficiently secured, in addition to complete coincidence of the transmission timing between object signals. In this embodiment, for example, when a lag in timing between the “input signal DI1 from outside” and the “light source drive signal DO3 output from the modulation device 20” falls within the range of the standards of visible light communication, it is included in the range (concept) of “synchronizing.” Note that the “determination on whether or not the external ID signal has been input” and the “transmission timing” will be described in detail in “Operation of light emission apparatus” to be described later.

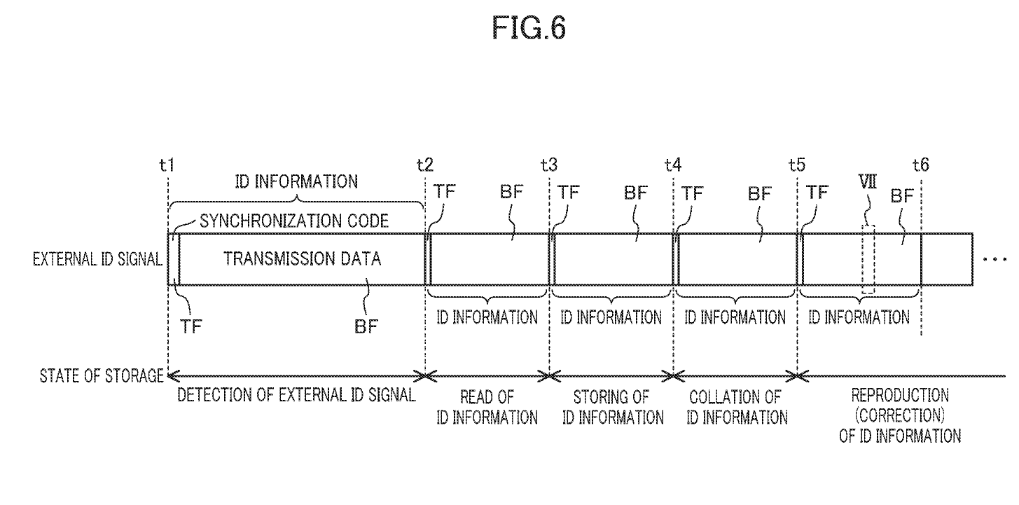

The ID information as used herein refers to an identification code including transmission data (e.g., URL of a website) as the object to be transmitted in the visible light communication, and the concrete form thereof is not specifically limited. For example, as the ID information, an identification code modulated by 4 pulse position modulation (4PPM) and conforming to JEITA Standards CP-1223 can be used. The ID information includes a synchronization code (preamble code) for indicating the start of the ID information as well as for synchronization and the above-described transmission data (see FIG. 6). Note that the ID information may include length information and an error correction code such as cyclic redundancy check (CRC).

Note that the ID information included in the external ID signal is hereinafter referred to as “external ID information” as distinguished from “internal ID information” that is ID information previously stored in an internal ID storage 24 to be described later. In other words, the external ID information is information extracted from the external ID signal and constituted by an identification code that does not include timing information related to signal transmission.

More specifically, the arithmetic processor 27 includes an external ID storage 22 and a corrector 23. When determining that an external ID signal has been input via the signal input unit 21, the external ID storage 22 acquires ID information from the external ID signal and stores the information. The corrector 23 obtains transmission timing synchronizing with the input signal DI1 from outside based on the external ID signal, and also outputs a light source drive signal DO2 corresponding to the ID information stored in the external ID storage 22 based on the transmission timing. In other words, the external ID storage 22 and the corrector 23, positioned downstream of the signal input unit 21, are configured to receive the input signal DI2 via the signal input unit 21. Further, the corrector 23, connected to the external ID storage 22, receives a light source drive signal DO1 to be described later output from the external ID storage 22. As the external ID storage 22, memory of a microcomputer, for example, can be used. The corrector 23 can be implemented by a program of a microcomputer. The “storing operation into the external ID storage 22” and the “correcting operation by the corrector 23” will be described later in detail in “Operation of light emission apparatus.”

Note that, in this embodiment, part of the configuration and/or functions of the arithmetic processor 27 may be constituted by a circuit. For example, the corrector 23 may be constituted by a delay circuit configured so that the delay time can be changed. In this case, the delay circuit may be configured to be able to delay the input signal by a predetermined delay amount or a delay amount set in the microcomputer and output the delayed signal. The concrete configuration of the delay circuit is not specifically limited as various configurations are conventionally known. Also, the selector 25 may be constituted by a circuit that outputs one of signals at two inputs. When the selector 25 is implemented by a circuit, the signal output unit 26 may be omitted from the configuration in FIG. 3, and the selector 25 may have both the function of the selector and the output function (buffer function) of the signal output unit 26.

The arithmetic processor 27 may further include the internal ID storage 24 as a storage and a selector 25 as a signal selection part. In the internal ID storage 24, internal ID information preset for each modulation device 20 has been registered. The selector 25 selects either one of a light source drive signal DO4 based on the internal ID information and the light source drive signal DO2 output from the corrector 23, and outputs the selected one as the light source drive signal DO3. The internal ID information is previously stored in the internal ID storage 24 at the time of manufacture/delivery of the modulation device 20, for example.

The light source drive signal DO2 output from the corrector 23 is given to the switch 14 via the selector 25 if the selector 25 is provided or directly if no selector is provided.

Further, the modulation device 20 may include a signal output unit 26 that outputs the light source drive signal DO3 output from the selector 25 outside the modulation device 20 (light emission apparatus 10). For example, when a plurality of light emission apparatuses 10 are connected in series as shown in FIGS. 1 and 2, the signal output unit 26 outputs the light source drive signal DO3 received from the selector 25 to the subsequent light emission apparatus 10 connected downstream. In the subsequent light emission apparatus 10, the output signal (light source drive signal DO3) from the preceding signal output unit 26 is given to the signal input unit 21 as the input signal DI1.

Note that, in this embodiment, while the external ID storage 22 and the internal ID storage 24 are illustrated and described as different blocks (components), the configuration is not limited to this. For example, the external ID storage 22 and the internal ID storage 24 may be configured to have separate memory regions in the same memory. Also, while the external ID storage 22 and the internal ID storage 24 are included in the arithmetic processor 27 in this embodiment, there is no intension of limiting the configuration of these blocks 22, 24, and 27 to the one-component configuration. That is, the arithmetic processor 27 and the external ID storage 22 and/or the internal ID storage 24 may be configured as separate components. For the other blocks, also, block splitting is merely for convenience sake: one block may be constituted by one component (unit) or by a plurality of components (units).

—Operation of Light Emission Apparatus—

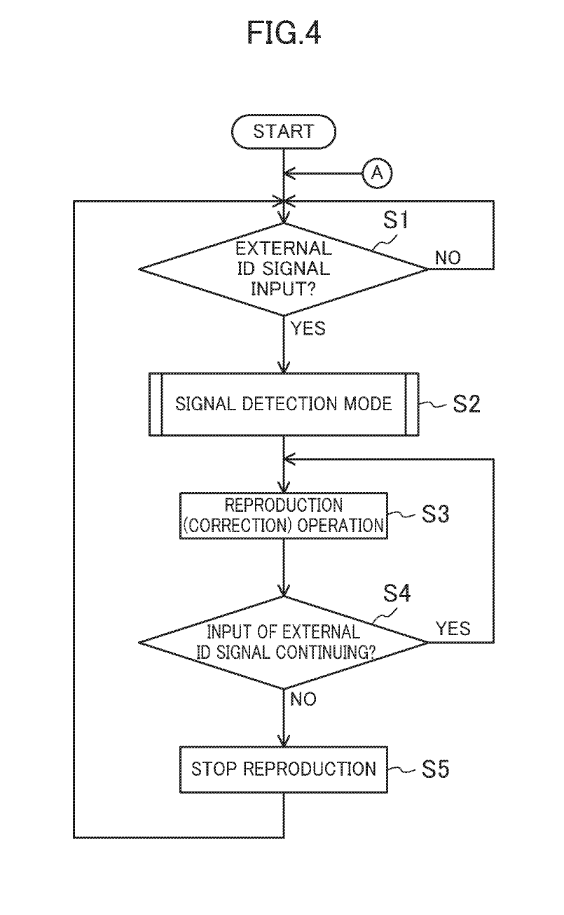

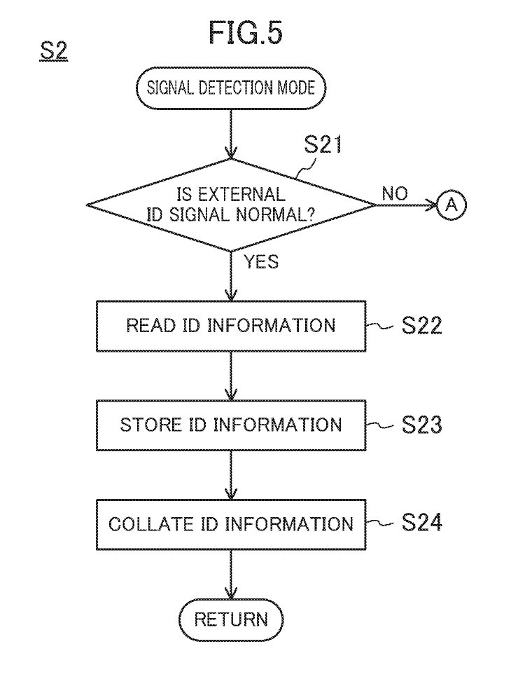

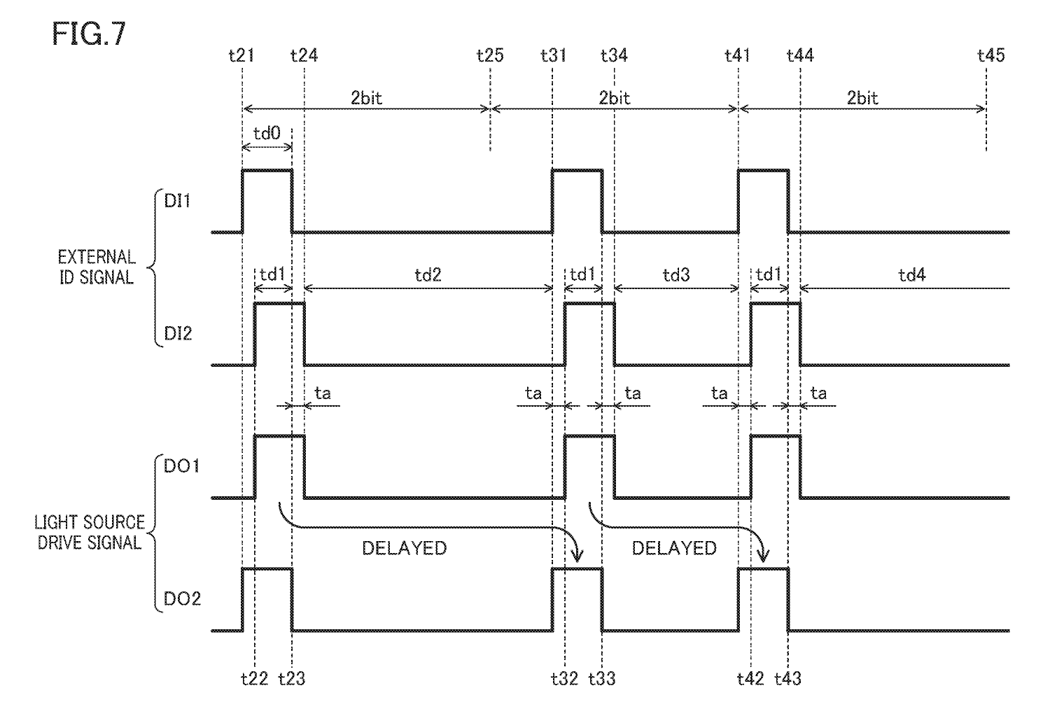

Next, the operation of the light emission apparatus 10 will be described in detail. FIGS. 4 and 5 are flowcharts showing the operation of the light emission apparatus 10, and FIGS. 6 and 7 are timing charts for explaining the operation of the light emission apparatus 10. FIG. 7 is an example of the timing chart in region VII in FIG. 6.

First, in step S1 in FIG. 4, the arithmetic processor 27 determines whether or not the external ID signal has been input via the signal input unit 21. When determining that the external ID signal has been input in step S1 (YES in S1), the arithmetic processor 27 performs the operation in a signal detection mode shown in FIG. 5 (step S2).

The signal detection mode will be described specifically as follows. First, in step S21 in FIG. 5, the arithmetic processor 27 determines whether or not the external ID signal is a normal ID signal. For example, the determination on whether or not the external ID signal is a normal ID signal is performed based on whether or not predetermined conditions, like conditions (1) and (2) below, have been satisfied:

(1) the external ID signal should have a format defined by the standards and the modulation scheme, and

(2) a specific code string (e.g., a synchronization code) should be included in the external ID signal.

As shown in FIG. 6, in the visible light communication, as the external ID signal, the same external ID information is repeatedly transmitted in synchronization with predetermined timing, for example. The length of each external ID information in the external ID signal is approximately one second, for example. Therefore, by checking whether or not there is the same code string as the synchronization code in the external ID signal, the arithmetic processor 27 can check whether or not conditions (1) and (2) are satisfied, for example. Step S21 is executed between time t1 and t2 in FIG. 6, for example.

When determining that the external ID signal is a normal ID signal (YES in S21), the arithmetic processor 27 reads the external ID information from the external ID signal in step S22. For example, the arithmetic processor 27 reads ID information sent next to the ID information used in step S21. Step S22 is executed between time t2 and t3 in FIG. 6, for example. On the other hand, when the arithmetic processor 27 determines that the external ID signal is not a normal ID signal (NO in S21), the flow returns to step S1.

Once the read of the ID information by the arithmetic processor 27 is finished, the ID information is stored in the external ID storage 22 in step S23. FIG. 6 shows an example that the ID information is stored after the read of the ID information in step S22 is completely finished (see time t2 to t3 in FIG. 6). The procedure is not limited to this, but the read operation in step S22 and the storing operation in step S23 may be executed in parallel (e.g., executed between time t2 and t3 in FIG. 6).

In step S24, the external ID information stored in the external ID storage 22 is collated with external ID information received at different timing (e.g., external ID information received between time t3 and t4 in FIG. 6). When the collation of the external ID information is finished, the arithmetic processor 27 outputs the external ID information stored in the external ID storage 22 to the corrector 23. Specifically, the flow returns to step S3 in FIG. 4, and the arithmetic processor 27 performs the operation in a reproduction mode of outputting the light source drive signal DO1 formed by repeated reproduction of the external ID information stored in the external ID storage 22.

The operation in the reproduction mode will be described hereinafter in a specific way.

As shown in FIG. 7, in the reproduction mode, the external ID storage 22 outputs the light source drive signal DO1 in synchronization with the external ID signal DI2 received from the signal input unit. The light source drive signal DO1 output from the external ID storage 22 is input into the corrector 23. The corrector 23 obtains transmission timing synchronizing with the input signal DI1 based on the timing (e.g., the rising edge and/or the falling edge) of the external ID signal DI2 received from the signal input unit 21.

Specifically, in FIG. 7, time ta indicates the difference between the external ID signal DI1 and the external ID signal DI2 caused by the transmission delay of the signal input unit 21. Since the time ta is caused by the transmission delay of components (mainly, the photocoupler 21a) constituting each modulation device 20, it can be grasped by measurement, etc. during production and delivery inspection. Therefore, by previously storing the time ta in the arithmetic processor 27, it is possible to obtain the transmission timing (e.g., delay times td1 to td4 by which the signal is delayed by the corrector 23).

The corrector 23 then delays the light source drive signal DO1 based on the obtained transmission timing and outputs the delayed signal to the selector 25 (signal output unit 26) as the light source drive signal DO2.

In step S4, the arithmetic processor 27 determines whether or not the external ID signal DI2 is being continuously input. When determining that the external ID signal DI2 is being continuously input (YES in S4), the arithmetic processor 27 continues the operation in the reproduction mode. When determining that the external ID signal DI2 has no longer been input (NO in S4), the arithmetic processor 27 deletes the external ID information stored in the external ID storage 22. Also, the arithmetic processor 27 stops the output of the light source drive signals DO1 and DO2 from the external ID storage 22 and the corrector 23, and the flow returns to step S1. At this time, the arithmetic processor 27 may control the selector 25 to switch to the internal ID storage 24 side to allow the light source drive signal DO4 (internal ID information) to be output from the selector 25 as the light source drive signal DO3. In this case, the internal ID storage 24 outputs the light source drive signal DO4 based on preset transmission timing, for example. Note that the determination that the “external ID signal has no longer been input” in step S4 may be made when the state of having no input of the external ID signal has continued for a predetermined time or longer, for example.

As described above, the modulation device 20 of the light emission apparatus 10 according to this embodiment includes the signal input unit 21 that receives the input signal DI1 from outside and outputs the signal downstream and the arithmetic processor 27 positioned downstream of the signal input unit 21. When determining that an external ID signal has been input as the input signal DI2, the arithmetic processor 27 acquires external ID information as the ID information from the external ID signal. Further, the arithmetic processor 27 obtains transmission timing synchronizing with the input signal DI1 based on the external ID signal, and outputs the light source drive signal DO3 corresponding to the external ID information based on the transmission timing.

As described above, since the arithmetic processor 27 obtains transmission timing for synchronization with the input signal DI1 from outside and transmits the light source drive signal DO3 at this transmission timing, it is possible to output the light source drive signal DO3 (ID signal) synchronizing with the input signal DI1. Thus, even in the case of a number of light emission apparatuses 10 (modulation devices 20) connected (in series in FIG. 1), it is possible to prevent occurrence of a lag in the timing of the blinking signals (outgoing signals for visible light communication) of the light emission apparatuses 10. In this way, the readability of ID information can be sufficiently secured irrespective of the number of light sources 13 (light emission apparatuses 10, modulation devices 20) installed.

In this embodiment, also, the arithmetic processor 27 of the modulation device 20 includes the external ID storage 22 as a storage and the corrector 23. The external ID storage 22 stores external ID information acquired from the external ID signal. The corrector 23 obtains transmission timing (for transmission of the light source drive signal DO3) and also outputs the light source drive signal DO2 (DO3) corresponding to the external ID information stored in the external ID storage 22 at the transmission timing. In this form, since the configuration is made so as to store the external ID information in the external ID storage 22 and output the light source drive signal DO3 based on the stored external ID information, blinking of the light source 13 with higher reliability (higher reproducibility of ID information) can be implemented. Therefore, the readability of ID information can be sufficiently secured irrespective of the number of light sources 13 (light emission apparatuses 10, modulation devices 20) installed.

In the arithmetic processor 27 of the modulation device 20 of this embodiment, the external ID storage 22 outputs the stored ID information in synchronization with the external ID signal as the light source drive signal DO1 that is an intermediate ID signal. The corrector 23, receiving the light source drive signal DO1 output from the external ID storage 22, delays the light source drive signal DO1 based on the transmission timing and outputs the delayed signal as the light source drive signal DO2 (DO3). With this, it is possible to prevent occurrence of a lag in the timing of the blinking signal output from the light emission apparatus 10, and thus the readability of ID information can be sufficiently secured irrespective of the number of light sources 13 (light emission apparatuses 10, modulation devices 20) installed.

The signal input unit 21 of the modulation device 20 of this embodiment has a light converter that converts the input signal DI1 to light energy. With this, the input signal DI1 in the signal input unit 21 (outside the modulation device 20) can be isolated from the arithmetic processor 27.

The arithmetic processor 27 of the modulation device 20 of this embodiment obtains transmission timing (for transmission of the light source drive signal DO3) based on the timing of the external ID signal acquired from the external ID signal and a predetermined transmission delay of the photocoupler 21a as the light converter. The photocoupler 21a is responsible for a large share of the transmission delay of the modulation device 20. Therefore, by obtaining the transmission timing based on the transmission timing of the external ID signal and the transmission delay of the photocoupler 21a, synchronization between the input signal DI1 and the light source drive signal DO3 (transmission timing) can be achieved comparatively easily with high precision.

In the arithmetic processor 27 of the modulation device 20 of this embodiment, internal ID information preset for each modulation device 20 has been registered in the internal ID storage 24 as a storage. When determining that no external ID signal has been input in the signal input unit 21, the arithmetic processor 27 outputs the light source drive signal DO3 corresponding to the internal ID information. With this, it is possible to provide the modulation device 20 applicable even in the state of having no input of an external ID signal, that is, applicable to an independent (stand-alone) light source (light emission apparatus 10) having no input of an external ID signal.

In the arithmetic processor 27 of the modulation device 20 of this embodiment, the external ID storage 22 deletes the ID information stored in the external ID memory 22 when a state of having no input of the external ID signal has continued for a predetermined time or longer after a last acquisition of the external ID information. With this, it is possible to avoid occurrence of an error at the time of connection change of the modulation devices 20 more reliably. Further, with a temporal margin provided, it is possible to prevent the possibility that the ID information may be deleted although the external ID signal is being continuously received.

The light emission apparatus 10 of this embodiment incudes the light source 13, the DC power source 11 as the power source supplying electric power to the light source 13, the switch 14 provided between the light source 13 and the DC power source 11 for controlling an on/off state of the connection therebetween, and the modulation device 20 according to any of the forms described above. The modulation device 20 blinks the light source 13 according to ID information by controlling the on/off state of the switch 14 with the light source drive signal DO3.

Thus, even in the case of a number of light emission apparatuses 10 connected (in series in FIG. 1), it is possible to prevent occurrence of a lag in the blinking signals (signals for visible light communication) output by the light emission apparatuses 10. In this way, the readability of ID information can be sufficiently secured irrespective of the number of light emission apparatuses 10 installed.

Also, the light emission apparatus 10 of this embodiment includes the signal output unit 26 that outputs the light source drive signal DO3 outside the light emission apparatus 10 based on the transmission timing. This makes it possible to connect a plurality of light emission apparatuses 10 in series after installation, improving the easiness of installation.

The modulation method for light source drive according to this embodiment, involving receiving the input signal DI1 from outside and outputting the light source drive signal DO3 for blinking the light source 13 according to ID information, includes the detecting step, the ID acquiring step, the deriving step, and the signal outputting step. In the detecting step, an external ID signal including external ID information is detected from the input signal DI1. In the ID acquiring step, the ID information is acquired from the external ID signal detected in the detecting step. In the deriving step, transmission timing for synchronization with the input signal is obtained from the receiving timing of the external ID signal detected in the detecting step. In the signal outputting step, the light source drive signal DO3 corresponding to the external ID information acquired in the ID acquiring step is output at the transmission timing obtained in the deriving step. In this way, it is possible to output the light source drive signal DO3 (ID signal) synchronizing with the input signal DI1. Therefore, even in the case of a number of light emission apparatuses 10 (modulation devices 20) connected (in series in FIG. 1), it is possible to prevent occurrence of a lag in the timing of the blinking signals (outgoing signals for visible light communication) of the light emission apparatuses 10. That is, the readability of ID information can be sufficiently secured irrespective of the number of light sources 13 (light emission apparatuses 10, modulation devices 20) installed.

### OTHER EMBODIMENTS

While a preferred embodiment has been described above to illustrate the technology disclosed herein, the disclosed technology is not limited to this, but is also applicable to other embodiments having undergone appropriate changes, replacements, additions, omissions, etc. Also, the components described in the above embodiment may be combined to provide new embodiments.

The above embodiment may be changed to the following configurations.

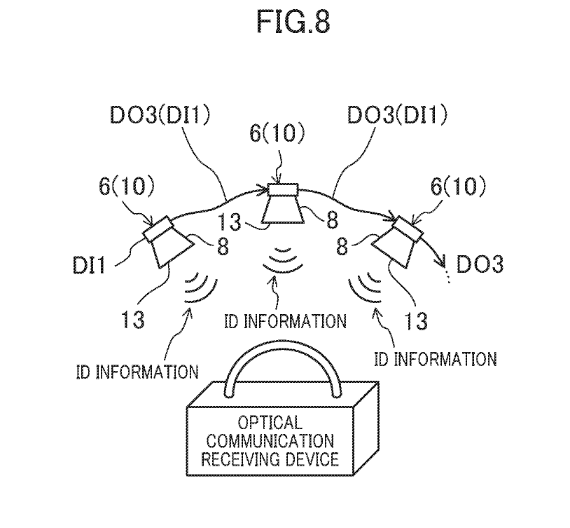

For example, while an example of applying the modulation device 20 and the light emission apparatus 10 including the same to the digital signage 1 was described in the above embodiment, the application is not limited to this. For example, they are applicable to self-lighting and/or inner-lighting signboards, other than the digital signage 1, installed in stations, etc. Also, as shown in FIG. 8, they may be applied to lighting fixtures 6. In this case, also, by applying light emission apparatuses 10 having a configuration similar to that of the above embodiment to the lighting fixtures 6, similar advantages can be achieved. Concretely, the lighting fixture 6 has the light emission apparatus 10 of which the light source 13 is attached so that light be radiated outside, and includes a housing that accommodates the switch 14 of the light emission apparatus 10 and the modulation device 20.

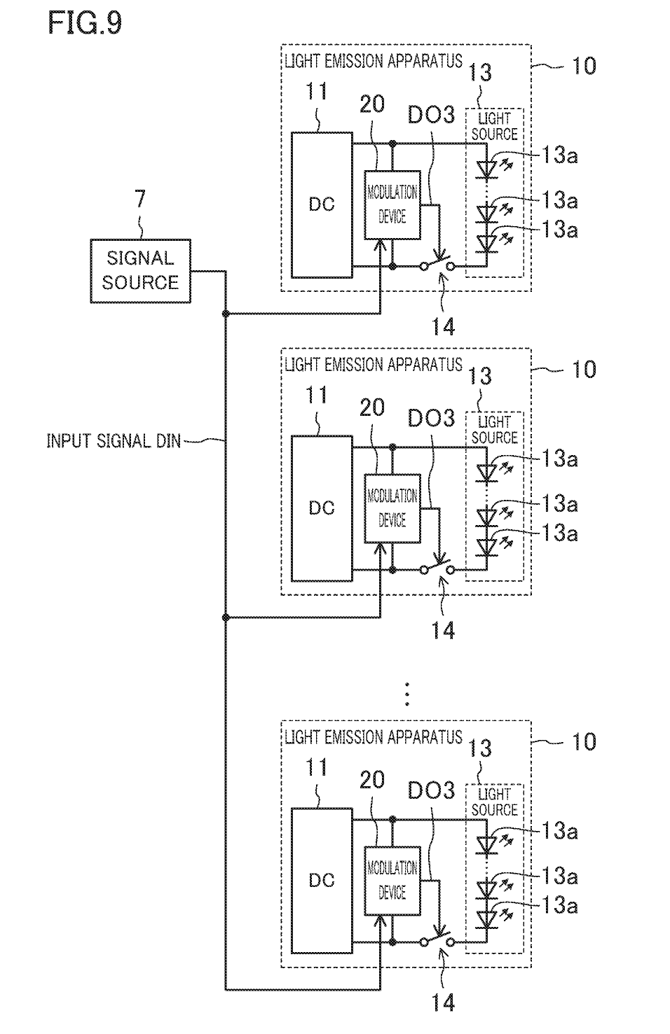

Also, while an example of connecting a plurality of signboards and lighting apparatuses (light emission apparatuses) in series was described in the above embodiment and the configuration in FIG. 8, the connection is not limited to this. For example, as shown in FIG. 9, a plurality of light emission apparatuses 10 may be connected in parallel with respect to a signal source 7 that generates an external ID signal. The transmission delay of the signal input unit 21 (e.g., the photocoupler 21a) of the modulation device 20 may vary between devices (light emission apparatuses 10, modulation devices 20). By applying the present disclosure, however, even when there are variations between devices, variations in blinking between the light sources 13 of the devices can be eliminated. Thus, the readability of ID information can be sufficiently secured irrespective of the number of light sources installed.

While the external ID storage 22 outputs the light source drive signal DO1 synchronizing with the external ID signal DI2 received from the signal input unit 21, and the corrector 23 delays the light source drive signal DO1 and outputs the delayed signal as the light source drive signal DO2 (DO3) in the above embodiment, the configuration is not limited to this. For example, the corrector 23 may obtain transmission timing synchronizing with the input signal DI1 based on the external ID signal, and make the external ID storage 22 output the light source drive signal DO1 (DO3) synchronizing with the input signal DI1 at this transmission timing. Otherwise, for example, the output signal from the signal input unit 21 may be allowed to pass through the external ID storage 22 without external ID information being stored, and directly input into the corrector 23. In this case, the corrector 23 may delay the external ID signal received from the signal input unit 21 based on transmission timing previously obtained, and output the delayed signal to the signal output unit 26 as the light source drive signal DO2 (DO3).

In the above embodiment, the modulation device 20 (light emission apparatus 10) may be provided with neither the internal ID storage 24 nor the selector 25. In this case, for example, the light source drive signal DO2 output from the corrector 23 may be directly supplied to the switch 14 and the signal output unit 26.

In step S4 in FIG. 4, whether or not the external ID signal is being continuously input is determined, and, when the determination is that the external ID signal has no longer been received, the external ID information is deleted. The procedure is not limited to this. For example, steps S4 and S5 in FIG. 4 may be cancelled, to allow the modulation device (light emission apparatus) to continue the operation in the reproduction mode in step S3, and once the light emission apparatus is powered off, the external ID information stored in the external ID storage may be deleted. Otherwise, the external ID information stored in the external ID storage may be deleted after another set of external ID information is received from the signal input unit.

The modulation device and the light emission apparatus including the same according to the present disclosure have an advantage of being capable of blinking a light source in the light emission apparatus so that the readability of ID information can be sufficiently secured irrespective of the number of light emission apparatuses installed, and are mainly useful as ones for signboards and lighting fixtures configured to permit visible light communication.

1. A modulation device comprising:
a signal input circuit that receives an external input signal and outputs the signal downstream as a first signal; and
an arithmetic processor positioned downstream of the signal input circuit, the arithmetic processor being configured to:
determine when an external ID signal including ID information has been input as the first signal, and when determining that an external ID signal including ID information has been input as the first signal, acquire the ID information from the external ID signal, obtain transmission timing synchronizing with the first signal based on the external ID signal, and output a light source drive signal that drives a light source according to the ID information based on the transmission timing synchronizing with the input signal.

2. The modulation device of claim 1, wherein
the arithmetic processor includes
a storage that stores the ID information acquired from the external ID signal, and
a corrector that acquires the transmission timing and outputs the light source drive signal corresponding to the ID information stored in the storage based on the transmission timing.

3. The modulation device of claim 1, wherein
the arithmetic processor has a storage that stores the ID information acquired from the external ID signal, and
the modulation device includes a correction circuit that outputs the light source drive signal corresponding to the ID information stored in the storage based on the transmission timing.

4. The modulation device of claim 2, wherein
the storage outputs the stored ID information in synchronization with the external ID signal as an intermediate ID signal, and
the corrector receives the intermediate ID signal output from the storage, delays the intermediate ID signal based on the transmission timing, and outputs the delayed signal as the light source drive signal.

5. The modulation device of claim 2, wherein
the signal input circuit includes a light converter that converts the input signal to light energy.

6. The modulation device of claim 5, wherein
the arithmetic processor obtains the transmission timing based on timing of the external ID signal acquired from the external ID signal and a predetermined transmission delay of the light converter.

7. The modulation device of claim 2, wherein
internal ID information uniquely preset for the modulation device has been registered in the storage, and
when determining that the external ID signal has not been input in the signal input circuit, the arithmetic processor outputs the light source drive signal corresponding to the internal ID information.

8. The modulation device of claim 2, wherein
the storage deletes the ID information stored in the storage when a state of having no input of the external ID signal has continued for a predetermined time or longer after a last acquisition of the ID information.

9. A light emission apparatus comprising:
a light source;
a power source that supplies electric power to the light source;
a switch provided between the light source and the power source for controlling an on/off state of a connection between the light source and the power source; and
the modulation device of claim 1,
wherein
the modulation device blinks the light source according to the ID information by controlling the on/off state of the switch with the light source drive signal.

10. The light emission apparatus of claim 9, comprising a signal output circuit that outputs the light source drive signal outside the light emission apparatus based on the transmission timing.

11. A lighting fixture comprising: the light emission apparatus of claim 9 attached so that light from the light source be radiated outside; and
a housing that accommodates the switch and the modulation device.

12. A signboard comprising: the light source, the power source, the switch, and the modulation device of the light emission apparatus of claim 9; and a housing that accommodates these components.

13. A signboard comprising a housing that accommodates the light fixture of claim 11.

14. A modulation method comprising the steps of:
detecting an external ID signal including ID information from an external input signal;
acquiring the ID information from the external ID signal detected in the step of detecting;
obtaining transmission timing for synchronization with the input signal from receiving timing of the external ID signal detected in the step of detecting; and
outputting a light source drive signal that drives a light source according to the ID information acquired in the step of acquiring at the transmission timing for synchronization with the input signal obtained in the step of obtaining.
